(19) United States
(12) Patent Application Publication
(10) Pub. No.: US 2007/0279675 A1
(43) Pub. Date: Dec. 6, 2007

(54) System and method for intelligent management of document processing jobs

(75) Inventors: Tony T. Quach, Anaheim, CA (US); Sheng W. Lee, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/445,883

(22) Filed: Jun. 2, 2006

(51) Int. Cl. G06F 3/12

(52) U.S. Cl. 358/1.15

(57) ABSTRACT

The subject application is directed to a system and method for selective intelligent job output control. A device driver receives a document processing request and output document processing device selection. The device driver queries the selected document processing device to determine whether it is available for operations. When it is not available, the device driver queries similar models of the device on the computer network to locate an alternative device. The alternative device or devices status is then ascertained and used for selecting an available output device.

### BACKGROUND OF THE INVENTION

The subject application is directed to a system and method for intelligent management of document processing jobs. In particular, the subject application is directed to a system and method for allowing a user to transmit a document processing job to any available document processing device on the system or network and to divide the processing of the job between two or more devices if the job is a certain size.

Typically, when a user desires to generate an electronic document, the user transmits the electronic document to a document processing device. Generally, the user will transmit the electronic document to a default document processing device selected either by the user or an administrator. One issue with such systems is if the document processing device is malfunctioning, the user may still be able to submit jobs to the device, but the device will not process any jobs until the device is again operational. Further, the selected device may be busy processing prior jobs. The user would not know that the document processing device was malfunctioning or busy until after the user has submitted the job to the device. The user would then have to either wait until the device was operational or available or manually cancel the job and transmit the job to another available device. Another issue is that the job may be of such a size that it will require a lengthy processing time by the selected document processing device due to constraints of the selected device. As such, the user must wait an extended time for the completion of the job, during which time the device is unavailable for other processing jobs. Therefore, there is a need for a system and method for intelligent management of document processing jobs.

The subject application overcomes the above noted problems and provides a system and method for intelligent management of document processing jobs such that a user may transmit the job to any available document processing device and divide the processing of the job between two or more devices if the job is a certain size.

### SUMMARY OF THE INVENTION

In accordance with the subject application, there is provided a system and method for intelligent management of document processing jobs.

Further, in accordance with the subject application, there is provided a system and method for allowing a user to transmit a document processing job to any available document processing device on the system or network and to divide the processing of the job between two or more devices if the job is a certain size.

Still further, in accordance with the subject application, there is provided a system for selective intelligent job output control. The system comprises means adapted for receiving a document output request into a workstation, which document output request corresponds to at least one electronic document and means adapted for receiving status data from each of a plurality of networked document processing devices. The system further comprises means adapted for prompting an associated user for selection data representative of an at least one intelligent job routing option associated with the at least one electronic document and the document output request and means adapted for receiving, from the associated user, selection data representative of a selection for intelligent job routing. The system also comprises testing means adapted for testing the status data in accordance with received selection data and routing means adapted for routing the at least one electronic document to at least one of the plurality of document output devices in accordance with an output of the testing means.

Still further, in accordance with the subject application, there is provided a method for selective intelligent job output control. The method includes the steps of receiving a document output request into a workstation, which document output request corresponds to at least one electronic document and receiving status data from each of a plurality of networked document processing devices. An associated user is prompted for selection data representative of an at least one intelligent job routing option associated with the at least one electronic document and the document output request and the selection is received from the user. The status data is then tested in accordance with received selection data and the at least one electronic document is routed to at least one of the plurality of document output devices in accordance with an output of the testing the status data.

Preferably, the status data includes data representative of a workload of each of the plurality of networked document processing devices.

In one embodiment, the document output request includes data identifying a primary one of the plurality of networked document processing devices and selection data includes data representative of a permission to route the at least one document to at least one alternative document processing device selected from the plurality thereof. The system and method also include the ability to route the at least one electronic document to at least one alternative document processing device to the primary document processing device.

In another embodiment, the selection data further includes data representative of a permission to route a portion of the at least one electronic document to each of the plurality of networked workstations. The system and method also include the ability to route the at least one electronic document a unique portion of the at least one electronic document to each of the plurality of networked workstations.

In yet another embodiment, the system and method further include the ability to apportion the at least one electronic document among the plurality of networked workstations in accordance with page count data associated therewith.

In a further embodiment, the system and method also have the ability to generate an output representative of a routing operation undertaken by the routing means.

Still other advantages, aspects and features of the subject application will become readily apparent to those skilled in the art from the following description wherein there is shown and described a preferred embodiment of this subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system illustrating the system for selective intelligent job output control according to the subject application;

FIG. 2 is a block diagram illustrating workstation hardware for use in the system for selective intelligent job output control according to the subject application;

FIG. 3 is a flowchart illustrating a method for selective intelligent job output control according to the subject application; and

FIG. 4 is a flowchart illustrating a method for selective intelligent job output control according to the subject application.

### DETAILED DESCRIPTION OF THE PREFERRED EMBODIMENT

The subject application is directed a system and method for intelligent management of document processing jobs. In particular, the subject application is directed to a system and method for selective intelligent job output control. More particularly, the subject application is directed to a system and method for allowing a user to transmit a document processing job to any available document processing device on the system or network and to divide the processing of the job between two or more devices if the job is a certain size.

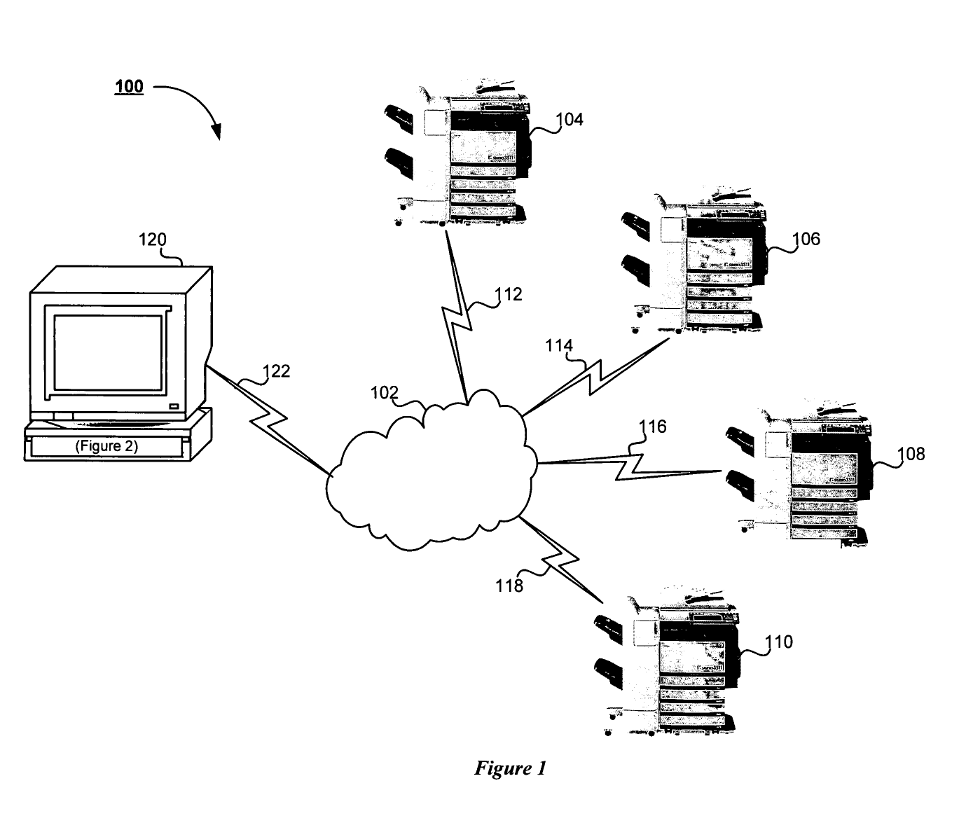

Referring now to FIG. 1, there is shown an overall diagram illustrating the system 100 for selective intelligent job output control in accordance with the subject application. As depicted in FIG. 1, the system 100 employs a distributed computing environment, represented as a computer network 102. It will be appreciated by the skilled artisan that the computer network 102 is any distributed communications environment known in the art capable of allowing two or more electronic devices to exchange data. Those skilled in the art will understand that the computer network 102 is any computer network, known in the art, including for example, and without limitation, a local area network, a wide area network, a personal area network, a virtual network, an intranet, the Internet, or any combination thereof. In the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wire-based or wireless data communication mechanisms.

The system 100 further includes a plurality of networked document processing devices, shown in FIG. 1 as the document processing device 104, the document processing device 106, the document processing device 108, and the document processing device 110. It will be understood by those skilled in the art that the subject application is suitably applicable to any number of document processing devices and need not be limited solely to the four shown in FIG. 1. The skilled artisan will appreciate that the document processing devices 104, 106, 108, and 110 are represented in FIG. 1 as multifunction peripheral devices, suitably adapted to perform a variety of document processing operations. It will be understood by those skilled in the art that suitable document processing operations include, for example and without limitation, electronic mail, scanning, copying, facsimile, document management, printing, and the like. Suitable commercially available network-capable document processing devices include, but are not limited to, the Toshiba e-Studio Series Controller.

In accordance with one embodiment of the subject application, the document processing devices 104, 106, 108, and 110 are suitably equipped to receive a plurality of portable storage media, including without limitation, Firewire drive, USB drive, SD, MMC, XD, Compact Flash, Memory Stick, and the like. In the preferred embodiment of the subject application, each document processing device 104, 106, 108, and 110, further include an associated user-interface, such as a touch-screen interface, LCD display, or the like, via which an associated user is able to interact directly with the respective document processing device 104, 106, 108, and 110. Preferably, each of the document processing devices 104, 106, 108, and 110 is suitably equipped with a data storage (not shown), suitably adapted to provide document storage, user information storage, network identification information, and the like. It will be appreciated by those skilled in the art that the data storage (not shown) is any mass storage device known in the art including, for example and without limitation, a hard disk drive, other magnetic storage devices, optical storage devices, flash memory devices, or any combination thereof.

In accordance with one embodiment of the subject application, the document processing device 104 is in data communication with the computer network 102 via a suitable communications link 112. As will be appreciated by the skilled artisan, a suitable communications link 112 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art. Similarly, the document processing devices 106, 108, and 110 are in data communication with the computer network 102 via suitable communications links 114, 116, and 118, respectively. As set forth above, a suitable communications link includes, for example and without limitation, the public switched telephone network, 802.11a, 802.11b, 802.11g, 802.11(x), a proprietary communications network, WiMax, infrared, optical, Bluetooth, or any other suitable wired or wireless data transmission communications known in the art.

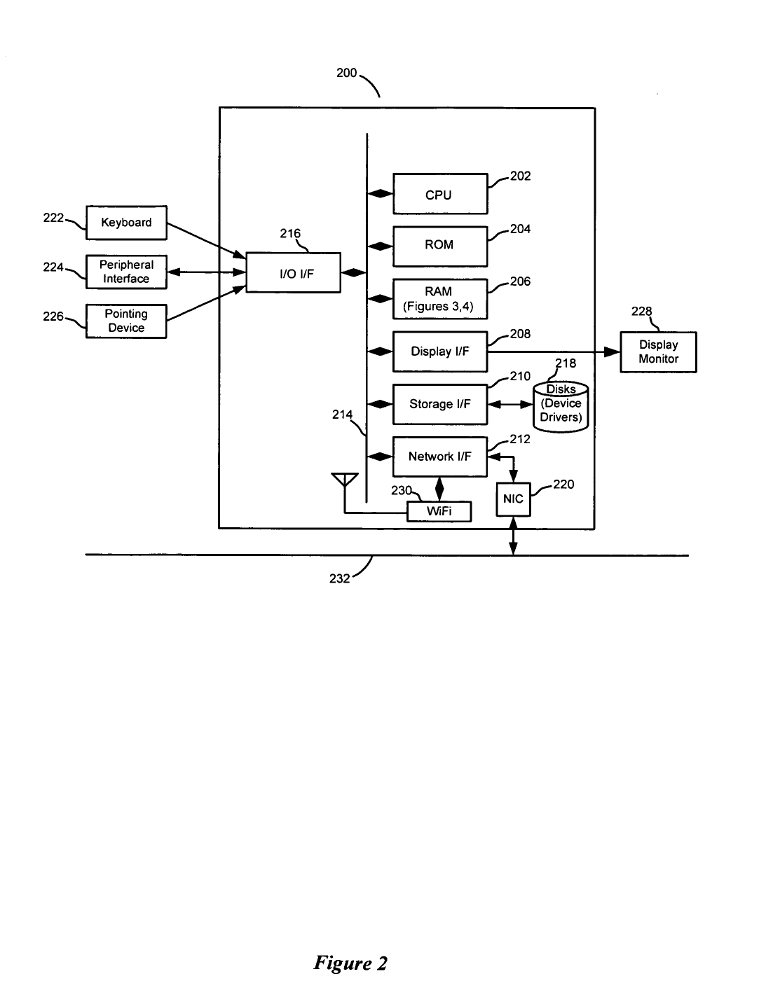

The system 100 illustrated in FIG. 1 further includes at least one user device, represented as the computer workstation 120. Preferably, the user device, e.g., workstation 120, is communicatively coupled to the computer network 102 via a suitable communications link 122. As the skilled artisan will understand, the workstation 120 shown in FIG. 1 is representative of any personal computing device known in the art, including, for example and without limitation, a laptop computer, a personal computer, a personal data assistant, a web-enabled cellular telephone, a smart phone, or other web-enabled electronic device. In the preferred embodiment of the subject application, the workstation 120 is embodied as hardware, software, or any suitable combination thereof, configured to request document processing operations, run suitably device drivers, and the like. The functioning of the workstation 120 will better be understood in conjunction with the block diagram illustrated in FIG. 2 and discussed in greater detail below.

Preferably, the workstation 120 includes one or more device drivers, suitably adapted to facilitate the communication of document processing requests to a document processing device 104, 106, 108, 110. As will be understood by those skilled in the art, a driver is representative of a computer program that enables another program, such as an operating system, word processing application, etc., to interact with a hardware device. In accordance with the subject application, the workstation 120 employs a printer driver, suitably adapted to convert data from an operating system, application, or the like, from one format to a format specific to a given document processing device. The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

Turning now to FIG. 2, illustrated is a hardware diagram of a suitable workstation 200, depicted in FIG. 1 as the workstation 120, for use in connection with the subject system. A suitable workstation includes a processor unit 202 which is advantageously placed in data communication with read only memory 204, suitably non-volatile read only memory, volatile read only memory or a combination thereof, random access memory 206, display interface 208, storage interface 210, and network interface 212. In a preferred embodiment, interface to the foregoing modules is suitably accomplished via a bus 214.

Read only memory 204 suitably includes firmware, such as static data or fixed instructions, such as BIOS, system functions, configuration data, and other routines used for operation of the workstation 200 via CPU 202.

Random access memory 206 provides a storage area for data and instructions associated with applications and data handling accomplished by processor 202.

Display interface 208 receives data or instructions from other components on bus 214, which data is specific to generating a display to facilitate a user interface. Display interface 208 suitably provides output to a display terminal 226, suitably a video display device such as a monitor, LCD, plasma, or any other suitable visual output device as will be appreciated by one of ordinary skill in the art.

Storage interface 210 suitably provides a mechanism for non-volatile, bulk or long term storage of data or instructions in the workstation 200. Storage interface 210 suitably uses a storage mechanism, such as storage 218, suitably comprised of a disk, tape, CD, DVD, or other relatively higher capacity addressable or serial storage medium.

Network interface 212 suitably communicates to at least one other network interface, shown as network interface 220, such as a network interface card. It will be appreciated that by one or ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art.

An input/output interface 216 in data communication with bus 214 is suitably connected with an input device 222, such as a keyboard or the like. Input/output interface 216 also suitably provides data output to a peripheral interface 224, such as a USB, universal serial bus output, SCSI, Firewire (IEEE 1394) output, or any other interface as may be appropriate for a selected application. Finally, input/output interface 216 is suitably in data communication with a pointing device interface 228 for connection with devices, such as a mouse, light pen, touch screen, or the like.

In operation, the workstation 120, via an associated device driver, receives a document output request from an associated user. As the skilled artisan will appreciate, the document output, or processing, request, suitably includes, for example and without limitation, an electronic document, output preferences, and the like. The user is then prompted, by the device driver, to select a target document processing device for the document processing request. That is, the user selects a route by which the document processing request will be processed. For example, the user selects the document processing device or devices to output the document processing operation using a popup dialog displayed on the workstation 120. The skilled artisan will appreciate that the user associated with the workstation 120 is able to select one or more document processing devices 104, 106, 108, or 110 to fulfill the requested document processing operation. Once the device driver has received the user's selection of a desired route for processing the electronic document, the device driver transmits an inquiry to the document processing device or devices, for current status of each respective device, e.g., the current workload for each device, or the like. In the preferred embodiment of the subject application, the document processing device or devices are queried with a network management protocol supported by the target document processing device, such as, for example and without limitation, SNMP, or the like.

The device driver then determines whether the user has selected to split, i.e., divide, the document processing request between two or more document processing devices. When the document processing request, or job, is to remain with a single document processing device for output, the status data of the document processing device 104, 106, 108, or 110 is tested against the route selected by the user. When the primary target device 104 is not ready, i.e., is unavailable, the device driver compares the status data of other similar document processing devices 106, 108, and 110, e.g., the workloads corresponding to each device 106, 108, and 110, to determine whether any alternative document processing device is available. When the primary document processing device 104 is available, the document processing request is routed to the primary document processing device 104 for output. When the primary document processing device 104 is unavailable, the device driver determines whether any alternative document processing device 106, 108, or 110 is available. The job is then routed to the available alternative document processing device 106, 108, or 110. When no alternative document processing devices 106, 108, or 110 are available, the user is informed of the inability to output the electronic document.

In accordance with one aspect of the subject application, the routing selection by the user is capable of including the ability to divide a large document processing request into several requests, whereby multiple document processing devices 104, 106, 108, and 110, on the computer network 102 are requested to output distinct portions of the request. The skilled artisan will appreciate that this split is capable of being based upon, but is not limited to, page counts, color requirements, media sizes, or the like. Once the determination is made by the device driver that the user has selected to divide the document processing request among two or more document processing devices 104, 106, 108, or 110, as determined by the user selected routing, the status data regarding those document processing devices 104, 106, 108, and 110, are analyzed to determine whether any of those selected devices 104, 106, 108, or 110, are unavailable. It will be understood that non-ready or unavailable document processing devices are removed from the route and the remaining devices are capable of each sharing a portion of the non-responsive device's workload, one device taking over the entire workload, or the like. The skilled artisan will further appreciate that an alternative document processing device is capable of being used to replace the unavailable document processing device.

Once the available document processing devices 104, 106, 108, and 110 have been identified and the respective status data analyzed, the document processing request is divided into portions, with each portion designated for an individual document processing device 104, 106, 108, or 110. As previously discussed, splitting of the document processing request is suitably accomplished based upon predetermined page counts, processing requirements, or the like. The device driver, once splitting of the request in distinct portions has occurred, then routes each portion to the designated document processing devices 104, 106, 108, and 110, which thereafter perform the required document processing operations. The document processing device 104, 106, 108, or 110 information, including for example and without limitation, host name, location, and the like, is then presented to the user by the device driver upon completion of the document processing job.

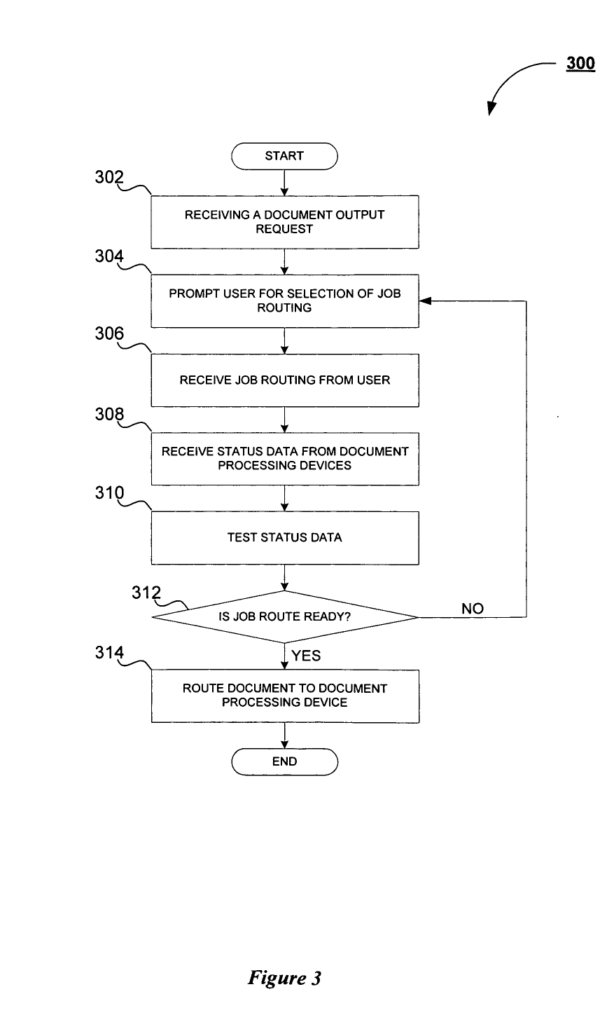

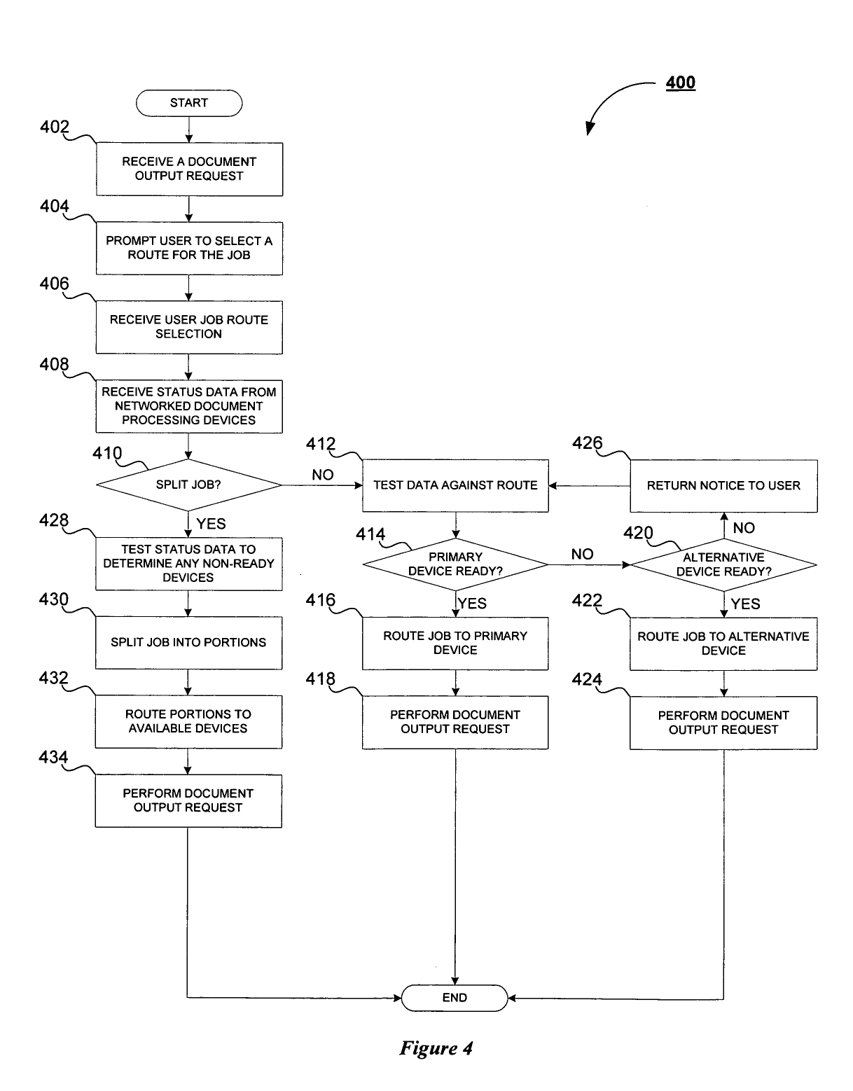

In accordance with the subject application, the system and method described herein, as reflected in FIG. 1, FIG. 2, FIG. 3, and FIG. 4, the device driver of the workstation 120 is suitably augmented with the ability to inquire as to the status of a desired document processing device 104, 106, 108, or 110 prior to submitting a document processing request to the document processing device. That is, when the user selects the option, such as “Smart Printing” in a device driver dialog, the device driver first inquires as to the status of the primary document processing device using a network management protocol supported by the targeted document processing device, e.g., SNMP. The skilled artisan will appreciate that the status data is representative of the current workload associated with the targeted document processing device, or other data reflecting the availability and/or capability of the targeted device to perform the requested function. The primary document processing device is queried first, with alternative document processing devices, of the same or similar model and capabilities, queried when the primary is unavailable. When the primary document processing device is available, the document processing request is submitted to the device for output. When the primary is not available, an alternative document processing device is selected and the job is processed by the alternative document processing device. The device information, including for example and without limitation, host name, location, and the like, is then presented to the user by the device driver upon completion of the document processing job.

In addition to the foregoing, the driver also has the capability of splitting a large job into two or more smaller jobs based on one or more settings, including, for example and without limitation, a configurable page threshold. When such action is selected by the user, or alternatively, is required due to the size of the job, document processing devices 104, 106, 108, 110 on the computer network 102 of the same or similar models are discovered and queried. Two or more devices, which need not be the primary device are selected to receive the sub-jobs. The document processing information is presented to the user upon successful submission. That is, the device driver generates and outputs to the user information relating to the routing operation just performed.

The foregoing system 100 and components illustrated in FIG. 1 and FIG. 2 will better be understood when viewed in conjunction with the methodology described in FIGS. 3 and 4, discussed hereinafter.

Turning now to FIG. 3, there is shown a flowchart 300 illustrating a method for selective intelligent job output control in accordance with the subject application. Beginning at step 302, a device driver associated with the workstation 120 receives a document output request from an associated user. Preferably, the document output request is initiated via a software application, such as a word processing program, or the like. At step 304 the device driver prompts the user to select a route for processing of a document processing job. This prompting is advantageously accomplished via a device driver dialog window, a popup window, or any other prompting known in the art. The user then selects a target document processing device 104, 106, 108, or 110 and other document processing options, such as, for example and without limitation, a number of copies, page orientation, output media, and the like. The job routing selection is then received by the device driver from the user at step 306, whereupon flow proceeds to step 308.

At step 308, status data is received by the device driver from the document processing device 104, 106, 108, or 110 as identified by the job routing selection of the user. In accordance with the subject application, the status data includes, for example and without limitation, data relating to the current workload of the identified document processing device 104, 106, 108, or 110. Preferably, the device driver sends a query to the selected, or target, document processing device 104, 106, 108, or 110 using a network management protocol supported by the targeted device 104, 106, 108, or 110. This status data is then tested at step 310 against the job routing selection to determine at step 312 whether the route is ready. That is, a determination is made at step 312 whether the selected document processing device 104, 106, 108, or 110 is available for performing the requested document processing operations. When the document processing device 104, 106, 108, or 110 is not available, flow returns to step 304, whereupon the user is prompted to select an alternative document processing device 104, 106, 108, or 110 to fulfill the desired document processing operation. When it is determined at step 312 that the route for the document processing request is ready, flow proceeds to step 314, whereupon the job is routed to the targeted document processing device 104, 106, 108, or 110. In accordance with the preferred embodiment of the subject application, the document processing device 104, 106, 108, or 110 information, including for example and without limitation, host name, location, and the like, is then presented to the user by the device driver upon completion of the document processing job. That is, the device driver generates an output representing the routing operation and displays the output to the user via the associated workstation 120, or the associated user-interface corresponding to the targeted device(s).

With respect to FIG. 4, there is shown a flowchart 400 illustrating a method for selective intelligent job output control in accordance with the subject application. A device driver associated with the workstation 120 receives a document output request, or document processing job at step 402. Preferably, the document output job includes data representative of an electronic document, as well as document processing instructions corresponding to desired document processing operations to be performed on the electronic document data. The device driver then prompts the user associated with the workstation 120 at step 404 to select a route for the job. That is, the device driver prompts the user to select the document processing device or devices 104, 106, 108, 110, to perform the requested document processing. At step 406, the device driver receives the user selection of a desired job processing route. Preferably, the user selection is received via a popup window or device driver dialog, so as to enable the device driver and the user to communicate.

The device driver then transmits a query to the document processing device or devices 104, 106, 108, 110 via a network management protocol understood by the device or devices 104, 106, 108, 110 for status data representing the current status of each document processing device 104, 106, 108, 110. Preferably, the status data includes, for example and without limitation, device 104, 106, 108, or 110 workload, availability, capabilities, and the like. The status data from each document processing device 104, 106, 108, 110 is then received at step 408 by the device driver of the workstation 120 and flow proceeds to step 410. At step 410 a determination is made whether the user, via the communications with the device driver, has selected to divide, or split, the document processing job, thereby enabling the processing of the job by more than one document processing device 104, 106, 108, 110. In accordance with the subject application, the user is able to divide processing of a given document processing request among two or more networked document processing devices 104, 106, 108, 110 via the device driver. That is, the device driver is suitably configured so as to have the capability of dividing a large job into two or more smaller jobs based on one or more factors, e.g., a configurable page threshold, or the like.

When it is determined at step 410 that the job is not going to be split, or alternatively does not meet a threshold for splitting, flow proceeds to step 412, whereupon the status data received from the target, or primary document processing device 104, 106, 108, 110, e.g., document processing device 104, is tested against the route to determine, at step 414, if the selected document processing device 104 is ready for receipt of the document processing request. When the primary document processing device 104 is ready at step 414, flow proceeds to step 416 whereupon the job is routed to the primary document processing device 104. The primary document processing device 104 then performs the requested document processing operation at step 418. In accordance with the preferred embodiment of the subject application, the document processing device 104 information, including for example and without limitation, host name, location, and the like, is then presented to the user by the device driver upon completion of the document processing job.

Returning to step 414, when it is determined that the primary document processing device 104 is not ready, or is unavailable for operations, flow proceeds to step 420, whereupon a determination is made whether an alternative document processing device 106, 108, or 110 is available. The skilled artisan will appreciate that the device driver is capable of requesting status data from each document processing device 106, 108, or 110 using the network management protocol at step 420 or at step 408, depending upon the configuration of the device driver. Preferably, the alternative document processing device 106, 108, or 110 is of the same or similar model as that of the primary document processing device 104. When an alternative document processing device 106, 108, or 110 is available and ready for processing operations, flow proceeds from step 420 to step 422, whereupon the job is routed to the alternative document processing device 106, 108, or 110. Thereafter, the alternative document processing device 106, 108, or 110 performs the requested document processing operation. In accordance with the preferred embodiment of the subject application, the document processing device 106, 108, or 110 information, including for example and without limitation, host name, location, other routing data, and the like, is then presented to the user by the device driver upon completion of the document processing job.

When it is determined at step 420 that no alternative document processing device 106, 108, or 110 is available for operations, flow proceeds to step 426, whereupon a notice is returned to the user informing the user that no document processing device, meeting the standards or capabilities of the primary document processing device 104 is available. Flow then returns to step 412, whereupon the additional status data of the document processing devices 104, 106, 108, and 110 is gathered and tested against the user selected route. For example, the status data includes device 104, 106, 108, or 110 workload, capabilities, availability, or the like. In accordance with one embodiment of the subject application, after returning the notification to the user, flow returns to step 404, whereupon the user is prompted to select a new primary document processing device from among those document processing devices communicatively coupled to the computer network 102.

Returning now to step 410, when it is determined by the device driver that the user has selected to split the document processing job, or the job is large enough that it is automatically divided, based on administrative settings, flow proceeds from step 410 to step 428. At step 428, the status data of each document processing device 104, 106, 108, and 110 is tested against the selected route to ascertain whether any document processing devices 104, 106, 108, or 110 corresponding to the split request are unavailable or not ready for processing operations. The original job is then divided into portions corresponding to the available document processing devices at step 430. The portions are then routed to the available document processing devices 104, 106, 108, 110 at step 432, whereupon the requested document processing operations are performed by the document processing devices 104, 106, 108, 110 at step 434. In accordance with the preferred embodiment of the subject application, the document processing device 104, 106, 108, or 110 information, including for example and without limitation, host name, location, and the like, is then presented to the user by the device driver upon completion of the document processing job by the devices 104, 106, 108, 110. That is, the device driver generates an output including the routing information for the user.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for selective intelligent job output control comprising:
means adapted for receiving a document output request into a workstation, which document output request corresponds to at least one electronic document;
means adapted for receiving status data from each of a plurality of networked document processing devices;
means adapted for prompting an associated user for selection data representative of an at least one intelligent job routing option associated with the at least one electronic document and the document output request;
means adapted for receiving, from the associated user, selection data representative of a selection for intelligent job routing;
testing means adapted for testing the status data in accordance with received selection data; and
routing means adapted for routing the at least one electronic document to at least one of the plurality of document output device in accordance with an output of the testing means.

2. The system for selective intelligent job output control of claim 1 wherein:
the document output request includes data identifying a primary one of the plurality of networked document processing devices;
selection data includes data representative of a permission to route the at least one document to at least one alternative document processing device selected from the plurality thereof; and
the routing means includes means adapted for routing the at least one electronic document to at least one alternative document processing device to the primary document processing device.

3. The system for selective intelligent job output control of claim 2 wherein:
the selection data further includes data representative of a permission to route a portion of the at least one electronic document to each of the plurality of networked document processing devices; and
the routing means includes apportionment means adapted for routing a unique portion of the at least one electronic document to each of the plurality of networked document processing devices.

4. The system for selective intelligent job output control of claim 3 wherein the apportionment means includes means adapted for apportioning the at least one electronic document among the plurality of networked document processing devices in accordance with page count data associated therewith.

5. The system for selective intelligent job output control of claim 4 further comprising means adapted for generating an output representative of a routing operation undertaken by the routing means.

6. The system for selective intelligent job output control of claim 1 wherein the status data includes data representative of a workload of each of the plurality of networked document processing devices.

7. A method for selective intelligent job output control comprising the steps of:
receiving a document output request into a workstation, which document output request corresponds to at least one electronic document;
receiving status data from each of a plurality of networked document processing devices;
prompting an associated user for selection data representative of an at least one intelligent job routing option associated with the at least one electronic document and the document output request;
receiving, from the associated user, selection data representative of a selection for intelligent job routing;
testing the status data in accordance with received selection data; and
routing the at least one electronic document to at least one of the plurality of document output device in accordance with an output of the testing the status data.

8. The method for selective intelligent job output control of claim 7 wherein:
the document output request includes data identifying a primary one of the plurality of networked document processing devices;
selection data includes data representative of a permission to route the at least one document to at least one alternative document processing device selected from the plurality thereof; and
the step of routing the at least one electronic document includes the step of routing the at least one electronic document to at least one alternative document processing device to the primary document processing device.

9. The method for selective intelligent job output control of claim 8 wherein:
the selection data further includes data representative of a permission to route a portion of the at least one electronic document to each of the plurality of networked document processing devices; and
the step of routing the at least one electronic document includes the step of routing a unique portion of the at least one electronic document to each of the plurality of networked document processing devices.

10. The method for selective intelligent job output control of claim 9 wherein step of routing a unique portion includes the step of apportioning the at least one electronic document among the plurality of networked workstations in accordance with page count data associated therewith.

11. The method for selective intelligent job output control of claim 10 further comprising the step of generating an output representative of a routing operation undertaken by the routing means.

12. The method for selective intelligent job output control of claim 1 wherein the status data includes data representative of a workload of each of the plurality of networked document processing devices.

13. A computer-implemented method for selective intelligent job output control comprising the steps of:
receiving a document output request into a workstation, which document output request corresponds to at least one electronic document;
receiving status data from each of a plurality of networked document processing devices;
prompting an associated user for selection data representative of an at least one intelligent job routing option associated with the at least one electronic document and the document output request;
receiving, from the associated user, selection data representative of a selection for intelligent job routing;
testing the status data in accordance with received selection data; and
routing the at least one electronic document to at least one of the plurality of document output device in accordance with an output of the testing of the status data.

14. The computer-implemented method for selective intelligent job output control of claim 13 wherein:
the document output request includes data identifying a primary one of the plurality of networked document processing devices;
selection data includes data representative of a permission to route the at least one document to at least one alternative document processing device selected from the plurality thereof; and
the step of routing the at least one electronic document includes the step of routing the at least one electronic document to at least one alternative document processing device to the primary document processing device.

15. The computer-implemented method for selective intelligent job output control of claim 14 wherein:
the selection data further includes data representative of a permission to route a portion of the at least one electronic document to each of the plurality of networked document processing devices; and
the step of routing the at least one electronic document includes the step of routing a unique portion of the at least one electronic document to each of the plurality of networked document processing devices.

16. The computer-implemented method for selective intelligent job output control of claim 15 wherein step of routing a unique portion includes the step of apportioning the at least one electronic document among the plurality of networked document processing devices in accordance with page count data associated therewith.

17. The computer-implemented method for selective intelligent job output control of claim 16 further comprising the step of generating an output representative of a routing operation undertaken by the routing means.

18. The computer-implemented method for selective intelligent job output control of claim 13 wherein the status data includes data representative of a workload of each of the plurality of networked document processing devices.
